(19) United States
(12) Patent Application Publication
(10) Pub. No.: US 2021/0097112 A1
(43) Pub. Date: Apr. 1, 2021

(54) WEBPAGE DATA PROCESSING METHOD AND DEVICE, COMPUTER DEVICE AND COMPUTER STORAGE MEDIUM

(71) Applicant: PING AN TECHNOLOGY (SHENZHEN) CO., LTD, Shenzhen (CN)

(72) Inventor: Shuzi Zhang, Shenzhen (CN)

(21) Appl. No.: 16/634,010

(22) PCT Filed: Feb. 23, 2018
(86) PCT No.: PCT/CN2018/077069

§ 371 Date: Jan. 24, 2020

(30) Foreign Application Priority Data
Dec. 30, 2017 (CN) 201711487763.3

(51) Int. Cl. G06F 16/951; H04L 29/12; G06F 16/953; H04L 29/06

(52) U.S. Cl. CPC G06F 16/951; H04L 61/6013; H04L 61/3055; H04L 63/1433; G06F 16/953; H04L 63/0884; H04L 61/1511

(57) ABSTRACT

A webpage data processing method and apparatus, a computer device and a storage medium, the method includes: acquiring first webpage data of a first webpage, querying a second webpage address associated with the first webpage data; acquiring a domain name of a website corresponding to a second webpage from the second webpage address, extracting a suffix of the domain name of the website corresponding to the second webpage; when the suffix of the domain name of the website corresponding to the second webpage is the same as a suffix of a pre-stored standard domain name, acquiring a network address corresponding to the standard domain name as a network address of the second webpage; accessing the second webpage according to the network address of the second webpage, and crawling second webpage data on the second webpage; respectively outputting the first webpage data and the second webpage data according to corresponding categories.

### CROSS REFERENCE TO RELATED APPLICATION

The present disclosure claims priority to the Chinese application No. 201711487763.3, titled “Webpage Data Processing Method and Apparatus, Computer Device and Computer Storage Medium”, filed on Dec. 30, 2017, the contents of which are herein incorporated by reference in their entirety.

### TECHNICAL FIELD

The present disclosure relates to the field of network security, and particularly to a webpage data processing method and apparatus, a computer device and a storage medium.

### BACKGROUND ART

With the development of Internet technology, in life, users can acquire more and more information from the network. In consequence, sometimes there are some related high-risk vulnerabilities or high-risk information related to the high-risk vulnerabilities. Therefore, it is very important to acquire the high-risk vulnerabilities or the information related to the high-risk vulnerabilities from the webpage.

Conventionally, the related high-risk vulnerabilities or the information related to the high-risk vulnerabilities are obtained through querying the corresponding webpage data from the currently known webpage and then analyzing the webpage data. However, a large number of webpage data may be omitted if the corresponding webpage data is queried only from the current webpage, resulting in inaccurate analysis of the webpage data.

### SUMMARY

In view of this, a webpage data processing method and apparatus, a computer device and a computer storage medium are provided according to various embodiments of the present disclosure, in order to address the one or more problems involved in the background art.

A webpage data processing method includes:

acquiring first webpage data of a first webpage, querying a second webpage address associated with the first webpage data;

acquiring a domain name of a website corresponding to a second webpage from the second webpage address, extracting a suffix of the domain name of the website corresponding to the second webpage;

when the suffix of the domain name of the website corresponding to the second webpage is the same as a suffix of a pre-stored standard domain name, acquiring a network address corresponding to the standard domain name as a network address of the second webpage;

accessing the second webpage according to the network address of the second webpage, and crawling second webpage data on the second webpage;

respectively outputting the first webpage data and the second webpage data to corresponding categories.

A webpage data processing apparatus includes:

a querying module, configured to acquire first webpage data of a first webpage and query a second webpage address associated with the first webpage data;

an extracting module, configured to acquire a domain name of a website corresponding to the second webpage from the second webpage address and extract a suffix of the domain name of the web site corresponding to the second webpage;

an acquiring module, configured to, when a suffix of a domain name of the website corresponding to the second webpage is the same as a suffix of a pre-stored standard domain name, acquire a network address corresponding to the standard domain name as a network address of the second webpage;

a crawling module, configured to access the second webpage according to the network address of the second webpage and crawl the second webpage data on the second webpage; and

an outputting module, configured to respectively output the first webpage data and the second webpage data to corresponding categories.

A computer device includes a processor and a memory storing computer readable instructions, which, when executed by the processor, cause the processor to implement steps including:

acquiring first webpage data of a first webpage, querying a second webpage address associated with the first webpage data;

acquiring a domain name of a website corresponding to a second webpage from the second webpage address, extracting a suffix of the domain name of the website corresponding to the second webpage;

when the suffix of the domain name of the website corresponding to the second webpage is the same as a suffix of a pre-stored standard domain name, acquiring a network address corresponding to the standard domain name as a network address of the second webpage;

accessing the second webpage according to the network address of the second webpage, and crawling second webpage data on the second webpage;

respectively outputting the first webpage data and the second webpage data to corresponding categories.

One or more non-transitory computer readable storage media storing computer readable instructions that, when executed by one or more processors, cause the one or more processors to perform steps comprising:

acquiring first webpage data of a first webpage, querying a second webpage address associated with the first webpage data;

acquiring a domain name of a website corresponding to a second webpage from the second webpage address, extracting a suffix of the domain name of the website corresponding to the second webpage;

when the suffix of the domain name of the website corresponding to the second webpage is the same as a suffix of a pre-stored standard domain name, acquiring a network address corresponding to the standard domain name as a network address of the second webpage;

accessing the second webpage according to the network address of the second webpage, and crawling second webpage data on the second webpage;

respectively outputting the first webpage data and the second webpage data to corresponding categories.

The details of one or more embodiments of the present disclosure will be provided in the following drawings and description. Other features and advantages of the present disclosure will become apparent from the specification, drawings and claims.

### BRIEF DESCRIPTION OF DRAWINGS

In order to illustrate the embodiments of the present disclosure or the technical solutions in the prior art more clearly, the accompanying drawings needed to use in the illustration of the embodiments or the prior art will be briefly described below. Apparently, the accompanying drawings in the following illustration are merely some embodiments of the present disclosure, and other drawings can be obtained according to these accompanying drawings without any creative work for those skilled in the art.

FIG. 1 is an application scenario diagram of a webpage data processing method in an embodiment;

FIG. 2 is a flow chart of a webpage data processing method in an embodiment;

FIG. 3 is a schematic structure diagram of a webpage data processing apparatus in an embodiment;

FIG. 4 is a schematic structure diagram of a computer device in an embodiment.

### DETAILED DESCRIPTION OF EMBODIMENTS

In order to make the objectives, technical solutions, and advantages of the present disclosure more comprehensible, the present disclosure will be further described in detail below with reference to the accompanying drawings and embodiments. It should be appreciated that the specific embodiments described herein are merely used for illustrating the present disclosure and are not intended to limit the present disclosure.

Before detailing the embodiments of the present disclosure, it should be noted that the described embodiments are primarily in combination of steps and apparatus components associated with webpage data processing method, apparatus, computer device, and storage medium. Accordingly, components of the apparatus and steps of the method have been shown in the appropriate positions in the accompanying drawings by means of the conventional signs, and only the details related to the understanding of the embodiments of the present disclosure are shown to avoid obscuring the disclosure of the present application caused by the details which are apparent for those skilled in the art.

In this article, relationship terms, such as left and right, up and down, before and after, first and second, etc., are only used to distinguish one entity or action from another entity or action, without necessarily requiring or implying any actual relationship or order of this kind between entities or actions. The terms “comprising”, “including” or any other variations are intended to cover a non-exclusive inclusion, such that a process, method, article, or device including a series of elements includes not only those elements but also other elements not explicitly listed, or an element inherent in such a process, method, article, or device.

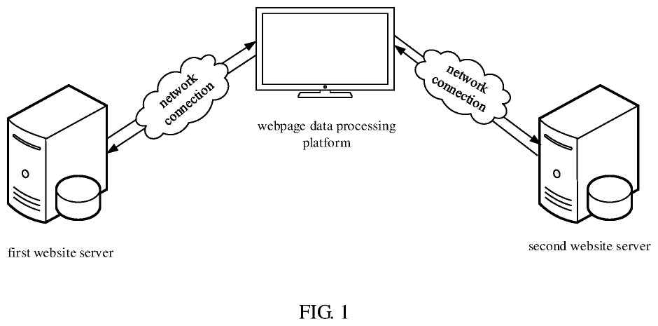

Referring to FIG. 1, FIG. 1 provides an application scenario diagram of a webpage data processing method, including a webpage data processing platform, a first website server, and a second website server. When acquiring webpage data of a first webpage from the first web site server, the webpage data processing platform queries an address of a second webpage corresponding to the first webpage data and then acquires a domain name of a website corresponding to the second webpage. When the suffix of the acquired domain name of the website is the same as the suffix of the pre-stored standard domain name, the webpage data processing platform acquires a network address corresponding to the standard domain name as the network address of the second webpage, and then sends a request for accessing the second webpage corresponding to the network address according to the network address of the second webpage. After the request is passed by the second website server, the webpage data processing platform accesses the second webpage and crawls the second webpage data on the second webpage, and then outputs the first webpage data and the second webpage data.

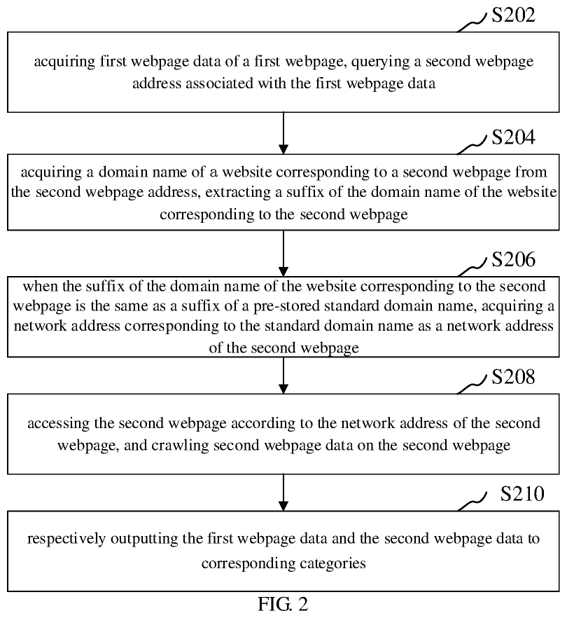

Referring to FIG. 2, a flow chart of a webpage data processing method is provided in an embodiment. In this embodiment, the method is applied to the webpage data processing platform in FIG. 1 as an example to illustrate that there is a webpage data processing program running on the platform and the webpage data processing is implemented through the webpage data processing program. The method includes the following steps:

S202: first webpage data of a first webpage is acquired, and an address of a second webpage associated with the first webpage data is queried.

Specifically, the first webpage refers to a webpage storing corresponding first webpage data. The first webpage may be a normal webpage directly searched by a search engine embedded in a common browser, and the first webpage may be a webpage stored in the first website server. The webpage data processing platform can directly find the server through an open network address, and then access the first webpage through the server to acquire the first webpage data on the first webpage. The first webpage data refers to a webpage content stored on the first webpage, and the first webpage data may be text data, image data or digital data. The second webpage refers to a webpage storing corresponding second webpage data. The second webpage may be a webpage that hides a network address, and this webpage cannot be directly searched by a search engine embedded in a common browser, for example, the second webpage can be a deep web or a dark web. A webpage address means that each webpage has a unique corresponding identifier in the network. For example, the webpage address may be a Uniform Resource Locator (URL) address, and the second webpage address refers to a webpage identifier of the second webpage; or the second webpage address may be the URL address of the second webpage. Furthermore, the request for accessing the first webpage is sent, and when the request is validated, the first webpage data of the first webpage is acquired; a second webpage address associated to the first webpage data is acquired in a query database. The specific process of acquiring the second webpage address associated to the first webpage data in a query database may include: matching is performed on to-be-matched data pre-stored in the query database through the first webpage data; when the matching is successful, the second webpage address corresponding to the to-be-matched data is acquired as the second webpage address corresponding to the first webpage data. For example, the webpage data processing platform sends a request for accessing the first webpage to the first web site server, and after the request is validated by the first website server, the webpage data processing platform can access the first webpage, and then acquire the first webpage data of the first webpage; the webpage data processing platform acquires the second webpage associated with the first webpage data in the query database according to the first webpage data.

It should be noted that the query database refers to a database storing corresponding webpage data and the corresponding webpage address associated with the webpage data. The query database may store corresponding webpage data associated with a webpage address which cannot be acquired directly, such as some dark or deep network address.

S204: a domain name of a website corresponding to the second webpage is acquired from the second webpage address, and a suffix of the domain name of the website corresponding to the second webpage is extracted.

Specifically, the domain name of the website refers to an identifier of the related web site, and the domain name of the web site can be acquired from the webpage address. For example, the domain name of the website “Baidu” is baidu.com, and there may be a plurality of webpage addresses each of which corresponds to a webpage under the domain name. The webpage address of the homepage of “Baidu” is www.baidu.com, and then the domain name of the website “Baidu” can be acquired from the webpage address of the homepage of “Baidu”. The suffix of the domain name of the website refers to a marker reflecting the category of the website according to the identifier of the website. The suffix of the domain name of the website may be a national domain name, a general domain name, etc., for example, the suffix of the domain name of the website may be “.com”, “.cn” and the like. Specifically, the domain name of the website corresponding to the second webpage is extracted from the acquired second webpage address, and then the suffix of the domain name of the web site is extracted from the acquired domain name of the website corresponding to the second webpage. For example, the webpage data processing platform acquires the domain name of the website corresponding to the second webpage from the second webpage address according to the acquired second webpage address, and then extracts the suffix of the domain name of the website corresponding to the second webpage from the acquired domain name of the website corresponding to the second webpage.

S206: when the suffix of the domain name of the website corresponding to the second webpage is the same as the suffix of the pre-stored standard domain name, a network address corresponding to the standard domain name is acquired as the network address of the second webpage.

Specifically, the standard domain name refers to a pre-stored domain name associated with a network address that can be used for accessing the corresponding webpage. The standard domain name may be a domain name of a website corresponding to a webpage that cannot be queried by a search engine embedded in a common browser, for example, the standard domain name may be a domain name of some deep or dark network. A network address refers to an address for uniquely identifying a computer device in the network. The computer device can use a network address as a communication identifier when communicating with other computer devices. The corresponding webpage is stored on the computer device and corresponds to the network address. For example, the network address may be an Internet Protocol (IP) address, etc. Furthermore, when matching is performed between the suffix of the acquired domain name of the website corresponding to the second webpage and the suffix of the pre-stored standard domain name, and if the suffix of the domain name of the website corresponding to the second webpage is the same as the suffix of the standard domain name, the first level matching is successful; and then the matching is performed between the other part of the domain name of the web site corresponding to the second webpage and the other part of the standard domain name, if the matching is successful, the network address corresponding to the successfully matched standard domain name is acquired as the network address of the second webpage. For example, some websites have particular domain name suffixes, such as the suffix of the domain name of the web site corresponding to a webpage of dark or deep network is “.onion”. The webpage data processing platform performs matching between the acquired suffix of the domain name of the website corresponding to the second webpage and the suffix of the standard domain name pre-stored in a domain name repository, and if the suffix of the domain name of the website corresponding to the second webpage is the same as the suffix of the standard domain name, the first level matching is successful; and then the matching is performed between the other part of the domain name of the website corresponding to the second webpage and the other part of the standard domain name, if the matching of the other part is also successful, the network address corresponding to the standard domain name is acquired as the network address of the second webpage. For example, if the domain name of the website corresponding to the second webpage acquired by webpage data processing platform is “abc.onion”, the suffix of the domain name of the second webpage is “.onion”; and when the suffix is the same as the suffix of the standard domain name in the domain name repository, the matching is performed on the other part of the standard domain name; when the matching of the other part is also successful, the network address corresponding to the successfully matched standard domain name stored in the domain name repository is acquired as the network address of the second webpage. It should be noted that the domain name repository refers to a database that stores a standard domain name to be matched and a network address corresponding to the standard domain name.

The suffix of the domain name of the web site corresponding to the second webpage is firstly matched to the suffix of the standard domain name, if the matching is successful, then the subsequent matching is performed, thereby the time saved and the efficiency is improved.

S208: the webpage is access according to the network address of the second webpage, and the second webpage data on the second webpage is crawled.

Specifically, the second webpage data refers to a webpage content stored on the second webpage. The second webpage data may be text data, image data or digital data. When acquiring the network address of the second webpage, the webpage data processing platform finds the second website server corresponding to the network address of the second webpage through querying according to the network address of the second webpage, and then sends the request for accessing the second webpage to the second website server, accesses the second webpage after the request is validated, and then crawls the second webpage data on the second webpage.

S210: the first webpage data and the second webpage data are output to respective categories.

Specifically, the webpage data processing platform outputs the acquired first webpage data the second webpage data together. Alternatively, the first webpage data and the second webpage data are output together to the database for storage according to the categories, or the first webpage data and the second webpage data are output together to the user for viewing according to the categories. Furthermore, the webpage data processing platform may store different categories of webpage data. When acquiring the first webpage data and the second webpage data, the webpage data processing platform extracts respective keywords of the first webpage data and the second webpage data respectively, and respectively stores, according to the extracted keyword of the first webpage data and the keyword of the second webpage data, the first webpage data and the second webpage data under respective categories corresponding to the respective extracted keywords. For example, the webpage data processing platform may store webpage data of “security vulnerability” category and “security update” category. When the keyword extracted from the first webpage data is “vulnerability”, the first webpage data is correspondingly stored under the “security vulnerability” category; when the keyword extracted from the second webpage data is “patch”, the second webpage data is correspondingly stored under the “security update” category.

In the present embodiment, the webpage data processing platform acquires the first webpage data of the first webpage, and then acquires the address of the second webpage corresponding to the first webpage data, acquires the domain name of the web site corresponding to the second webpage according to the second webpage address, acquires the network address of the second webpage according to the suffix of the domain name of the website corresponding to the second webpage; and then the webpage data processing platform accesses the second webpage according to the network address of the second webpage, so as to crawl the second webpage data and then output the first webpage data and the first webpage data together. The second webpage may be a webpage that cannot be queried by a general browser, and the second webpage data is stored on the second webpage. The second webpage data is acquired through the method of the present embodiment, consequently, the first webpage data and the second webpage data are acquired and output to corresponding categories, thereby preventing omission of the webpage data and improving the accuracy of data analysis.

In an embodiment, the step S208, that is, the second webpage is accessed according to the network address of the second webpage, and the second webpage data on the second webpage is crawled, may include:

When the second webpage carries an identifier of access restriction, a crawling instruction for crawling the webpage data on the second webpage is sent to a proxy server. Specifically, the identifier of access restriction refers to an identifier carried on the website which requires a specific computer device to access. The identifier of access restriction may be a character identifier or the like. The proxy server refers to a server with specific access rights. The second webpage carrying the identifier of access restriction can be accessed through the proxy server. The crawling instruction refers to an instruction for accessing a specified webpage to acquire the specified webpage data on a specified webpage. Furthermore, when the second webpage carries the identifier of access restriction, a specific computer device (may be a proxy server) is needed to access the second webpage, and then the webpage data processing platform sends a crawling instruction to the proxy server, so that the proxy server may access the second webpage to crawl the webpage data on the second webpage according to the crawling instruction.

An identity authentication request returned by the proxy server is received, and a corresponding identity identifier is sent to the proxy server according to the identity authentication request. Specifically, the identity authentication request refers to a request for right validation. The identity authentication request may be text data, picture data, or digital data. The identity identifier refers to identity information indicating a corresponding operation right, and the identity identifier may be the identity information having a right to send the crawling instruction. For example, the identity identifier may be text data, image data or digital data corresponding to the identity authentication request, e.g., the identity identifier may be a verification code, an account password or the like. Furthermore, when sending the crawling instruction to the proxy server, the webpage data processing platform receives an identity authentication request returned by the proxy server, and then the webpage data processing platform sends the corresponding identity identifier to the proxy server according to the identity authentication request. Alternatively, The webpage data processing platform sends a crawling instruction for crawling the second webpage data to the proxy server, and the proxy server returns an identity authentication request, and then a corresponding interface is popped up on the interface of the webpage data processing platform with displaying “please input operation username and password”. After the user completes the input of the username and password on the interface, the webpage data processing platform sends the username and password entered by the user, that is, the identity identifier, to the proxy server. It should be noted that the identity authentication request returned by the proxy server may also be a corresponding verification code. When the user inputs a corresponding verification code according to a prompt on the interface of the webpage data processing platform, then the webpage data processing platform sends the verification code input by the user to the proxy server, that is, sends the corresponding identity identifier to the proxy server.

When the identity identifier is successfully validated by the proxy server, the webpage data crawled from the second webpage and returned by the proxy server is received. Specifically, when the identity identifier sent by the webpage data processing platform to the proxy server is successfully validated by the proxy server, the webpage data processing platform has a right to send the crawling instruction to the proxy server after the authentication, and the proxy server can sends a request for accessing the second webpage to the proxy server according to the crawling instruction. After the request for accessing is successfully validated by the second website server, the proxy server accesses the second webpage to crawl the second webpage data, so that the webpage data processing platform receives the second webpage data crawled by the proxy server.

It should be noted that, in the present embodiment, the proxy server may adopt a shadowsocks (ss) system, to implement the above steps through the ss system to crawl the second webpage data.

In this embodiment, when the second webpage carries the identifier of access restriction, the second webpage data is crawled through the proxy server to enhance the applicability; and the proxy server is needed to authenticate the identity of the current operation when crawling the second webpage data, to ensure the security of the second webpage data transmission and interaction.

In an embodiment, the step S208, i.e., the step of accessing the webpage according to the network address of the second webpage and crawling the second webpage data on the second webpage, may further include:

When the second webpage does not carry the identifier of access restriction, a crawling logic and a communication protocol corresponding to the second webpage are acquired according to the second webpage address. Specifically, the crawling logic refers to a crawling rule adopted when crawling the webpage data on the webpage. The crawling logic may include an address of a webpage, and also stores a position of the webpage data of the webpage to be crawled (for example, may be the number of rows of the webpage data of the webpage to be crawled, or coordinates of a display area of the webpage in which the webpage data of the webpage to be crawled is located. The crawling logic may further include the number of webpage data acquired. The communication protocol refers to a corresponding communication rule or communication protocol which the webpage data processing platform and the website server comply with when communicating through the network. The communication protocol may be a communication mode using an HTTP communication protocol, or may be a communication mode using an FTP communication protocol or the like. Furthermore, when the second webpage does not carry the identifier of access restriction, the second webpage can be accessed directly through the webpage data processing platform; the webpage data processing platform acquires the pre-stored crawling logic for crawling the webpage data of the second webpage and then acquires a pre-stored communication protocol corresponding to the second webpage.

The second webpage is accessed and the second webpage data of the second webpage is traversed according to the communication protocol corresponding to the second webpage. Specifically, when acquiring the communication protocol corresponding to the second webpage, the webpage data processing platform sends the communication protocol corresponding to the second webpage and an access request to the second website server corresponding to the second webpage. When the second website server receives the communication protocol corresponding to the second webpage and the access request, after the received communication protocol and the access request are successful validated, the webpage data processing platform is allowed to access the second webpage, and then the webpage data processing platform traverses the webpage data on the second webpage, for example, the webpage data processing platform can query the text data in the webpage data line by line and character by character until the last character of the webpage data on the second webpage is queried, that is, the webpage data of the second webpage is traversed. Alternatively, the image data in the webpage data may be queried one by one image until the last image on the second webpage is queried to complete the traversal of the second webpage data of the second webpage.

When traversing the second webpage data corresponding to the crawling logic, the second webpage data corresponding to the crawling logic is crawled. Specifically, the crawling logic is preset with a position of the webpage data to be crawled, a keyword of the webpage data to be crawled, and the amount of data acquired when querying the data keyword of the webpage to be crawled, for example, when the second webpage data is text data, the position of the crawled text data preset in the logic is all the webpage data or the first five rows of webpage data, etc. The keyword of the webpage data to be crawled is set, and when the webpage data to be crawled is queried to include the keyword, the number of the webpage data including the keyword may be the first five rows of the webpage data including the keyword, all the webpage data, and the like. The webpage data processing platform traverses the second webpage data of the current second webpage, and when traversing the second webpage data corresponding to the crawling logic, the second webpage data corresponding to the crawling logic is crawled. Alternatively, the position of the webpage data of the webpage to be crawled pre-set in the crawling logic is all webpage data, and the keyword of the webpage data of the webpage to be crawled is set to be “Ping An Bank”, when the webpage data processing platform traverses the second webpage data of the second webpage, all the second webpage data is traversed; and when data corresponding to the “Ping An Bank” is queried, all the webpage data of the second webpage is crawled.

In this embodiment, when the second webpage does not carry the identifier of access restriction, the webpage data processing platform directly crawls the second webpage data of the second webpage, accordingly, the efficiency is improved; and the second webpage data on the second webpage is crawled according to the crawling rule, therefore, the data is crawled accurately to ensure accurate acquisition of the second webpage data.

In an embodiment, the step S210, i.e., the step of outputting the first webpage data and the second webpage data to corresponding categories, may include:

A webpage identifier carried by the first webpage data and a webpage identifier carried by the second webpage data are respectively matched to the stored webpage identifiers. The webpage identifier refers to an identifier of a webpage of the corresponding webpage data source. The webpage identifier can distinguish the webpage of the webpage data source from other webpages. The webpage identifier may be a name of a website corresponding to the webpage, or a webpage address, or domain name of a website corresponding to the webpage. For example, the webpage identifier may be a URL address of the webpage, or a domain name of a web site corresponding to the URL address of the webpage. Furthermore, the first webpage data acquired by the webpage data processing platform carries the webpage identifier of the corresponding first webpage, and the second webpage data carries the webpage identifier of the corresponding second webpage; and furthermore, the webpage data processing platform respectively matches the webpage identifier of the first webpage and the webpage identifier of the second webpage to the stored webpage identifiers. Alternatively, the webpage identifier carried on the first webpage data is matched to the stored webpage identifiers one by one in the main thread. When the matching between the webpage identifier carried on the first webpage data and the stored webpage identifiers is completed, the webpage identifier carried on the second webpage data is matched to the stored webpage identifiers one by one in the main thread. Alternatively, the webpage identifier carried on the first webpage data is matched to the stored webpage identifiers one by one in the main thread, and then the webpage identifiers carried on the first webpage data is matched to the stored webpage identifiers one by one in another thread asynchronous to the main thread. For example, the first webpage data, acquired by the webpage data processing platform, carries the URL address of the corresponding first webpage, the second webpage data carries the URL address of the corresponding second webpage, and then the webpage data processing platform respectively matches the URL address of the first webpage carried by the first webpage data and the URL address of the second webpage carried by the second webpage data to the stored URL addresses one by one.

When at least one of the webpage identifier carried by the first webpage data and the webpage identifier carried by the second webpage data does not match the stored webpage identifier, the keyword of the unmatched webpage data is extracted. Specifically, when the webpage data processing platform respectively matches the webpage identifier carried by the first webpage data and the webpage identifier carried by the second webpage data to the stored webpage identifiers one by one, at least one of the webpage identifier carried by the first webpage data and the webpage identifier carried by the second webpage data does not successfully match the stored webpage identifier, the unsuccessfully matched webpage data is not stored, and the keyword of the unmatched webpage data is extracted. Alternatively, when the webpage identifier carried by the first webpage data does not successfully match the stored webpage identifier, the first webpage data is not stored, and the keyword of the first webpage data is extracted. Alternatively, if the webpage identifier carried by the second webpage data does not successfully match the stored webpage identifier, the second webpage data is not stored, and the keyword of the second webpage data is extracted. Further alternatively, when both the webpage identifier carried by the first webpage data and the webpage identifier carried by the second webpage data do not successfully match the stored webpage identifiers, the first webpage data and the second webpage data are not stored, and then the keyword of the first webpage data and the keyword of the second webpage data are extracted.

The unmatched webpage data is output to the storage category corresponding to the keyword. Specifically, the webpage data processing platform stores different categories of webpage data. When the webpage data not stored is identified through the above steps, the keyword of the webpage data is extracted, and the unmatched webpage data is output according to the keyword and is stored according to storage category corresponding to the keyword. For example, the webpage data processing platform stores different categories of webpage data which may be industry news, security vulnerabilities, security updates, exploitation of vulnerabilities, international consultations, recommended readings, etc. For example, the keyword corresponding to industry news includes finance, bank, insurance, stock, credit card, payment, swift, bank, banks, etc. The keyword corresponding to security vulnerabilities includes daily security information, Common Vulnerabilities & Exposures (CVE) public vulnerabilities and exposures or vulnerabilities, etc. The keywords corresponding to security updates include update, patch, security update or upgrade, etc. If the first webpage data is not stored, the keyword of the first webpage data is extracted; and if the keyword of the first webpage data is “patch”, the first webpage data is output and accordingly stored under the “security vulnerability”. When the keyword of the current first webpage data is not the keyword corresponding to industry news, security vulnerabilities, security updates, exploitation of vulnerabilities and international consultations, the first webpage data is output and stored under the corresponding “recommended readings” category. When the second webpage data is not stored or both the first webpage data and the second webpage data are not stored, the webpage data not stored is output and stored under the corresponding storage category according to the above steps, and the details are not repeated here.

It should be noted that when the first webpage data and the second webpage data are acquired, there may be some special characters in the first webpage data and the second webpage data, such as underline, space or random code, etc. When there are special characters in the first webpage data and the second webpage data, conversion logics respectively corresponding to the first webpage data and the second webpage data are selected, and the first webpage data and the second webpage data are converted according to respective conversion logics, so that the underline, space or random code can be deleted. The conversion logic refers to a rule for converting webpage data into a specific display format or specific display data.

In the present embodiment, the acquired webpage identifier carried by the first webpage data and the webpage identifier carried by the second webpage data are matched to the stored webpage data to ensure that the webpage data is not repeatedly stored, so that the storage efficiency is improved; and then the webpage data not stored is stored under the corresponding category, which facilitates subsequent searching and enhances the applicability.

In an embodiment, the above method may further include:

A preset email address for receiving the first webpage data and the second webpage data is acquired. Specifically, the webpage data processing platform may push the stored first webpage data and the second webpage data, and a mailbox receiving the first webpage data and the second webpage data may be preset and stored; then the webpage data processing platform acquires an email address of the preset mailbox for receiving the first webpage data and the second webpage data.

A department identifier corresponding to the email address is extracted, and a storage category corresponding to the department identifier is acquired. Specifically, the department identifier refers to an identifier for identifying different organization. The department identifier may be a department name, a department code, etc. Specifically, when the webpage data processing platform acquires the email address of the preset mailbox for receiving the first webpage data and the second webpage data, the department identifier corresponding to the email address is extracted, and the storage category corresponding to the department is acquired according to the department identifier, that is, the category of the webpage data received by the department is acquired. Alternatively, the email address may include a corresponding department identifier, such as a department code. Then, the webpage data processing platform directly extracts the corresponding department identifier from the email address, and acquires the category of the webpage data received by the department according to the department identifier. Alternatively, when the email address is acquired, the webpage data processing platform matches the email address to the pre-stored email address, when the matching is successful, the department identifier corresponding to pre-stored and successfully matched email address is acquired as a department identifier of the email address; and the category of the webpage data received by the department is acquired according to the department identifier. For example, if the department identifier corresponding to the email address extracted by the webpage data processing platform is an industry analysis department, the acquired storage category corresponding to the industry analysis department is industry news.

The acquired first webpage data and second webpage data stored under the storage category are sent to the mailbox corresponding to the email address. Specifically, when acquiring the department identifier corresponding to the email address, the webpage data processing platform acquires the storage category corresponding to the department identifier and then sends the acquired first webpage data and the second webpage data under the storage category to the mailbox corresponding to the email address, and then adds a label to the first webpage data and the second webpage data which have been sent. For example, if the department identifier corresponding to the email address extracted by the webpage data processing platform is the industry analysis department, the acquired storage category corresponding to the industry analysis department is the industry news, and the first webpage data and the second webpage data stored under the industry news are sent to the mailbox corresponding to the email address, and the first webpage data and the second webpage data that have been sent are added with a sending completion label. It should be noted that the sending time may be preset. When the webpage data processing platform detects that the system time is the preset sending time, the acquired first webpage data and second webpage data under the storage category are sent to the mailbox corresponding to the email address.

In the present embodiment, the storage category corresponding to the department identifier is acquired according to the department identifier corresponding to the email address, and the first webpage data and the second webpage data corresponding to the storage category are sent to the mailbox corresponding to the webpage mailbox, that is, the first webpage data and the second webpage data which are of interest to the department are pushed according to the department identifier, the applicability is enhanced; and when the first webpage data and the second webpage data are added with a label after completing the sending thereof, repeatedly pushing is avoided, the efficiency is improved and the applicability is enhanced.

In an embodiment, the step of accessing the webpage according to the network address of the second webpage and crawling the second webpage data on the second webpage in the above embodiment may include:

A crawling time to crawl the second webpage data of the second webpage is preset. Specifically, the webpage data processing platform is provided with a crawling time to crawl the second webpage data of the second webpage, and the preset crawling time may be a fixed time, or an interval time period, etc. For example, a crawling time may be set on the hour, such as 8:00 AM, 10 AM, or every half an hour or an hour, etc.

When the crawling time is reached, an available crawling network address is randomly selected from the network address library. The crawling network address refers to a communication identifier adopted to communicate with the other party when crawling the second webpage data. For example, the crawling network address may be an IP address acquired by the webpage data processing platform. The network address library is a database which is preset in the webpage data processing platform and can store different network addresses. For example, the network address library can store different IP addresses such as a first IP address and a second IP address. Furthermore, when the webpage data platform detects that the preset crawling time is reached, the webpage data processing platform randomly selects an available crawling network address from the network address library, for example, when the first IP address is selected as the crawling network address, the selected first IP address may be marked, the marked first IP address is a network address in use; the next time the webpage crawling platform selects the network address from the network address library, the network address is selected from the unmarked network addresses; when the use of the marked network address, i.e., the first IP address, is completed, a mark of the network address is deleted.

The second webpage is accessed through the crawling network address, and the second webpage data on the second webpage is crawled. Specifically, when acquiring the crawling network address, the webpage data processing platform sends a communication protocol and an access request corresponding to the second webpage to the second website server. This time, the communication protocol and the access request carry the crawling network address. When the crawling network address is successfully validated by the second website server, the second website server verifies the communication protocol and the access request, when both the communication protocol and the access request are successfully validated, the webpage data processing platform accesses the second webpage, and crawls the second webpage data on the second web page according to the crawling logic.

In the present embodiment, when accessing the second webpage and crawling the webpage data on the second webpage, the webpage data processing platform randomly acquires a network address from the stored network addresses in the network address library, and then completes the subsequent crawling of the second webpage data on the second webpage, to avoid a situation in which the same network address are repeatedly used for crawling, accordingly, a risk control mechanism of the second webpage is triggered, resulting in unsuccessful crawling of the second webpage data. Therefore, the applicability is enhanced.

In an embodiment, the step of accessing the second webpage according to the network address of the second webpage and crawling the second webpage data on the second webpage in the above embodiment may include:

the second webpage is accessed according to the network address of the second webpage and querying whether the second webpage is rendered. Specifically, rendering refers to displaying the hidden data completely when part of the data on the second webpage is hidden when displayed. When accessing the second webpage, the webpage data processing platform detects whether there is hidden second webpage data on the second webpage. Alternatively, the webpage data processing platform detects whether there is data carrying a hiding label on the second webpage, and the second webpage is not rendered completely if the hiding label is carried. Alternatively, the webpage data processing platform detects whether the second webpage data on the second webpage requires a specific operation, the second webpage is not rendered completely if a specific operation is required. The specific operation may be an operation that requires the user to click prompt information “display full text”, and then the second webpage displays the hidden data after the user clicks the prompt information.

When the second webpage is not rendered completely, a rendering logic corresponding to the second webpage is acquired according to the second webpage address. Specifically, the rendering logic refers to a rule for completely displaying the hidden data on the webpage. When querying that the second webpage is not rendered completely, the webpage data processing platform selects the rendering rule corresponding to the second webpage according to the second webpage address.

The second webpage is rendered according to the rendering logic corresponding to the second webpage. Specifically, when querying that the second webpage is not rendered completely, the webpage data processing platform selects a rendering logic corresponding to the second webpage according to the second webpage address, and then renders the second webpage according to the rendering logic corresponding to the second webpage. When the second webpage is rendered completely, the display of the second webpage data on the second webpage is completed.

the second webpage data on the completely rendered second webpage is crawled. Specifically, according to the above steps, when the rendering of the second webpage is completed, the display of the second webpage data of the second webpage is completed, and the webpage data processing platform crawls the second webpage data on the completely rendered second webpage.

In the above embodiment, when the second webpage is not rendered completely, the rendering logic of the second webpage is selected according to the second webpage address; the second webpage data on the second webpage is crawled after the second webpage is rendered completely according to the rendering logic of the second webpage, thereby ensuring that the webpage data of the second webpage is crawled completely and avoiding missing data.

It should be appreciated that although the various steps in the flow chart of FIG. 2 are sequentially displayed as indicated by the arrows, these steps are not necessarily performed in the order indicated by the arrows. Except as explicitly stated herein, the execution of these steps is not strictly limited, and the steps may be performed in other orders. Moreover, at least some of the steps in FIG. 2 may include a plurality of sub-steps or stages, which are not necessarily performed at the same time, but may be executed at different times, the execution order of these sub-steps or stages is also not necessarily sequential, but may be performed in turns or alternately with other steps or at least part of the sub-steps or stages of the other steps.

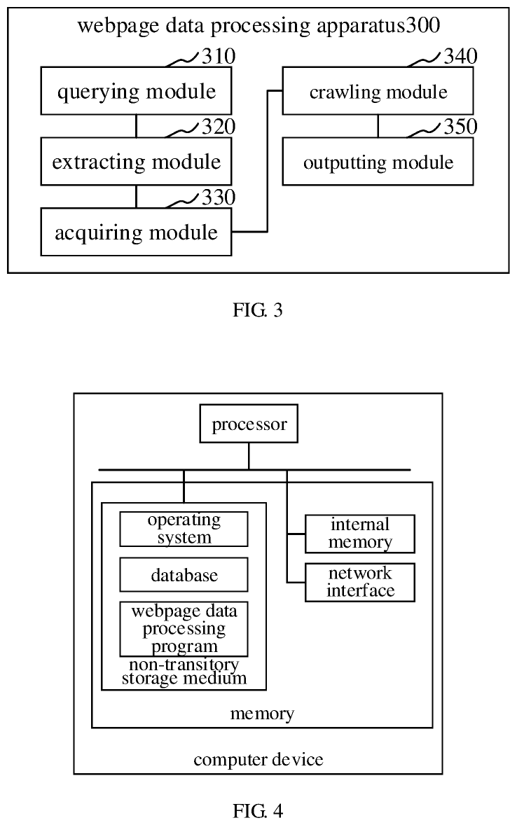

In an embodiment, referring to FIG. 3, a schematic structure diagram of a webpage data processing apparatus is provided, and the webpage data processing apparatus 300 may include:

a querying module 310 configured to acquire first webpage data of a first webpage, and query a second webpage address associated with the first webpage data;

an extracting module 320 configured to acquire a domain name of a website corresponding to the second webpage from the second webpage address, and extract a suffix of the domain name of the web site corresponding to the second webpage;

an acquiring module 330 configured to, when the suffix of the domain name of the website corresponding to the second webpage is the same as a suffix of a pre-stored standard domain name, acquire a network address corresponding to the standard domain name as a network address of the second webpage;

a crawling module 340 configured to access the second webpage according to the network address of the second webpage, and crawl second webpage data on the second webpage;

an outputting module 350 configured to respectively output the first webpage data and the second webpage data to corresponding categories.

In an embodiment, the crawling module 340 may include:

a sending unit configured to, when the second webpage carries an identifier of access restriction, send a crawling instruction for crawling webpage data on the second webpage to a proxy server;

a first receiving unit configured to receive an identity authentication request returned by the proxy server, and send a corresponding identity identifier to the proxy server according to the identity authentication request;

a second receiving unit configured to: when the identity identifier is successfully validated by the proxy server, receive the webpage data crawled from the second webpage and returned by the proxy server.

In an embodiment, the crawling module 340 may further include:

an acquiring unit configured to, when the second webpage does not carry the identifier of access restriction, acquire a crawling logic and a communication protocol corresponding to the second webpage according to the second webpage address;

a traversing unit configured to access the second webpage and traverse the second webpage data of the second webpage according to the communication protocol corresponding to the second webpage;

a second webpage data crawling unit configured to: when traversing the second webpage data corresponding to the crawling logic, crawl the second webpage data corresponding to the crawling logic.

In an embodiment, the output module 350 may include:

a matching unit configured to match a webpage identifier carried by the first webpage data and a webpage identifier carried by the second webpage data to a stored webpage identifier;

an extracting unit configured to, when at least one of the webpage identifier carried by the first webpage data and the webpage identifier carried by the second webpage data does not match the stored webpage identifier, extract a keyword of unmatched webpage data;

a storing unit configured to output the unmatched webpage data to a storage category corresponding to the keyword.

In an embodiment, the output module 350 may further include:

an email address acquiring unit configured to acquire a preset email address of a mailbox for receiving the first webpage data and the second webpage data;

a storage category acquiring unit configured to extract a department identifier corresponding to the email address, and acquire a storage category corresponding to the department identifier;

a data sending unit configured to send the first webpage data and the second webpage data under the acquired storage category to the mailbox corresponding to the email address.

In an embodiment, the crawling module 340 may further include:

a crawling time preset unit configured to preset a crawling time when the second webpage data of the second webpage is crawled;

a network address selecting unit configured to randomly select an available crawling network address from a network address library when the crawling time is reached;

an accessing unit configured to access the second webpage through the crawling network address, and crawl the second webpage data on the second webpage.

In an embodiment, the crawling module 340 may further include:

a rendering querying unit configured to access the second webpage according to the network address of the second webpage and query whether the second webpage is rendered completely;

a rendering logic acquiring unit configured to acquire a rendering logic corresponding to the second webpage according to the second webpage address when the second webpage is not rendered completely;

a rendering unit configured to render the second webpage according to the rendering logic corresponding to the second webpage;

a rendering data crawling unit configured to crawl the second webpage data on the completely rendered second webpage.

For the specific limitation to the webpage data processing apparatus, reference may be made to the webpage data processing method described above, and the details are not described herein again. The various modules in the webpage data processing apparatus described above may be implemented in whole or in part by software, hardware, and combinations thereof. Each of the above modules may be embedded in or independent of the processor in the computer device, or may be stored in a memory in the computer device in a software form, so that the processor calls and executes the operations corresponding to the above modules. The processor may be a central processing unit (CPU), a microprocessor, a microcontroller, or the like. The webpage data processing apparatus described above can be implemented in the form of computer readable instructions which can be executed on a webpage data processing platform device as shown in FIG. 1.

In an embodiment of the present disclosure, a computer device is provided, which may be a server, and an internal structure diagram thereof may be as shown in FIG. 4. The computer device includes a processor, a memory, a network interface and a database connected by a system bus. The processor of the computer device is used for providing computing and control capabilities. The memory of the computer device includes a non-transitory storage medium, an internal memory. The non-transitory storage medium stores an operating system, computer readable instructions and a database. The internal memory provides an environment for operation of the operating system and the computer readable instructions in the non-transitory storage medium. The database of the computer device is used for storing webpage data processing data. The network interface of the computer device is used for communicating with an external terminal via a network connection. The computer readable instructions are executed by a processor to implement a webpage data processing method.

It will be understood by those skilled in the art that the structure shown in FIG. 4 is only a block diagram of a part of the structure related to the solution of the present disclosure, and does not constitute a limitation to the computer device to which the solution of the present disclosure is applied. The specific computer device may include more or fewer components than those shown in the figures, or some components are combined, or have different component arrangements. The processor, when executing the computer readable instructions, implements the following steps: the first webpage data of the first webpage is acquired, the second webpage address associated with the first webpage data is queried; a domain name of a website corresponding to the second webpage is acquired from the second webpage address, a suffix of the domain name of the website corresponding to the second webpage is extracted; when the suffix of the domain name of the website corresponding to the second webpage is the same as the suffix of the pre-stored standard domain name, the network address corresponding to the standard domain name is acquired as the network address of the second webpage; the second webpage is accessed according to the network address of the second webpage, the second webpage data on the second webpage is crawled; and the first webpage data and the second webpage data are respectively output according to the corresponding categories.

In an embodiment, the step of accessing the second webpage according to the network address of the second webpage and crawling the second webpage data on the second webpage implemented when the computer readable instructions are executed by the processor, may include: when the second webpage carries the identifier of access restriction, the crawling instruction for crawling the webpage data on the second webpage is sent to the proxy server; an identity authentication request returned by the proxy server is received, and a corresponding identity identifier is sent to the proxy server according to the identity authentication request; when the identity identifier is successfully validated by the proxy server, the webpage data crawled from the second webpage and returned by the proxy server is received.

In an embodiment, the step of accessing the webpage according to the network address of the second webpage and crawling the second webpage data on the second webpage implemented when the computer readable instructions are executed by the processor, may include: when the second webpage does not carry the identifier of access restriction, the crawling logic and the communication protocol corresponding to the second webpage are acquired according to the second webpage address; the second webpage is accessed and the second webpage data of the second webpage is traversed according to the communication protocol corresponding to the second webpage; when traversing the second webpage data corresponding to the crawling logic, the second webpage data corresponding to the crawling logic is crawled.

In an embodiment, the step of respectively outputting the first webpage data and the second webpage data according to the corresponding categories implemented when the computer readable instructions are executed by the processor, may include: the webpage identifier carried by the first webpage data and the webpage identifier carried by the second webpage data are respectively matched to a stored webpage identifier; when at least one of the webpage identifier carried by the first webpage data and the webpage identifier carried by the second webpage data does not match the stored webpage identifier, the keyword of the unmatched webpage data is extracted; the unmatched webpage data is sent to the storage category corresponding to the keyword.

In an embodiment, the computer readable instructions may executed by the processor to further implement the steps: a preset email address of a mailbox for receiving the first webpage data and the second webpage data is acquired; the department identifier corresponding to the email address is extracted and the storage category corresponding to the department identifier is acquired; the acquired first webpage data and second webpage data under the storage category are sent to the mailbox corresponding to the email address.

In an embodiment, the step of accessing the webpage according to the network address of the second webpage and crawling the second webpage data on the second webpage implemented when the computer readable instructions are executed by the processor, may further include: a crawling time of the second webpage data of the second webpage; when the crawling time is reached, an available crawling network address is randomly selected from the network address library; the second webpage is accessed through the crawling network address, and the second webpage data on the second webpage is crawled.

In an embodiment, the step of accessing the second webpage according to the network address of the second webpage and crawling the second webpage data on the second webpage implemented when the computer readable instructions are executed by the processor, may include: the second webpage is accessed according to the network address of the second webpage and it is queried whether the second webpage is rendered completely; when the second webpage is not rendered completely, the rendering logic corresponding to the second webpage is acquired according to the second webpage address; the second webpage is rendered according to rendering logic corresponding to the second webpage; the second webpage data on the completely rendered second webpage is crawled.

For the specific limitation to the computer device, reference may be made to the webpage data processing method described above, and the details are not described herein again.

In an embodiment, referring to FIG. 4 again, a non-transitory computer readable storage medium storing computer readable instructions executed by one or more processors is provided, such that the one or more processors perform the steps of: acquiring first webpage data of the first webpage, and querying a second webpage address associated with the first webpage data; acquiring a domain name of a website corresponding to the second webpage from the second webpage address, and extracting a suffix of the domain name of the website corresponding to the second webpage; when the suffix of the domain name of the website corresponding to the second webpage is the same as the suffix of the pre-stored standard domain name, acquiring a network address corresponding to the standard domain name as the network address of the second webpage; accessing the second webpage according to the network address of the second webpage, and crawling the second webpage data on the second webpage; and respectively outputting the first webpage data and the second webpage data according to the corresponding categories.

For the specific limitation to the above-mentioned computer storage medium, reference may be made to the webpage data processing method described above, and details are not described herein again.

One of ordinary skill in the art can understand that all or part of the processes of implementing the above embodiments can be completed through instructing the related hardware by computer readable instructions. The computer readable instructions can be stored in a non-transitory computer readable storage medium, and may, when executed, include the flows of the embodiments of the above various methods. Any reference to a memory, storage, database or other medium used in the various embodiments provided herein may include non-transitory and/or transitory memory. The non-transitory memory can include read only memory (ROM), programmable ROM (PROM), electrically programmable ROM (EPROM), electrically erasable programmable ROM (EEPROM), or flash memory. Volatile memory can include random access memory (RAM) or external cache memory. By way of illustration and not limitation, RAM is available in a variety of formats, such as static RAM (SRAM), dynamic RAM (DRAM), synchronous DRAM (SDRAM), double data rate SDRAM (DDRSDRAM), enhanced SDRAM (ESDRAM), synchronization chain. Synchlink DRAM (SLDRAM), Memory Bus (Rambus) Direct RAM (RDRAM), Direct Memory Bus Dynamic RAM (DRDRAM), and Memory Bus Dynamic RAM (RDRAM).

The technical features of the above-described embodiments may be arbitrarily combined. For the sake of brevity of description, not all possible combinations of the technical features in the above embodiments are described. However, as long as there is no contradiction between the combinations of these technical features, all should be considered as the scope of the disclosure.

The above-mentioned embodiments are merely some embodiments of the present disclosure, and the description thereof is more specific and detailed, but is not to be construed as limiting the scope of the disclosure. It should be noted that a number of variations and modifications may be made by those skilled in the art without departing from the scope of the present disclosure, which are within the scope of the present disclosure. Therefore, the scope of the present disclosure should be determined by the appended claims.

1. A webpage data processing method, the method comprising:
acquiring first webpage data of a first webpage, querying a second webpage address associated with the first webpage data;
acquiring a domain name of a website corresponding to a second webpage from the second webpage address, extracting a suffix of the domain name of the website corresponding to the second webpage;
when the suffix of the domain name of the website corresponding to the second webpage is the same as a suffix of a pre-stored standard domain name, acquiring a network address corresponding to the standard domain name as a network address of the second webpage;
accessing the second webpage according to the network address of the second webpage, and crawling second webpage data on the second webpage; and
respectively outputting the first webpage data and the second webpage data according to corresponding categories.

2. The method according to claim 1, wherein the step of accessing the second webpage according to the network address of the second webpage, and crawling the second webpage data on the second webpage comprises:
when the second webpage carries an identifier of access restriction, sending a crawling instruction for crawling webpage data on the second webpage to the proxy server;
receiving an identity authentication request returned by the proxy server, and sending a corresponding identity identifier to the proxy server according to the identity authentication request; and
when the identity identifier is successfully validated by the proxy server, receiving webpage data which is crawled from the second webpage and returned by the proxy server.

3. The method according to claim 1, wherein the step of accessing the webpage according to the network address of the second webpage, and crawling the second webpage data on the second webpage comprises:
when the second webpage does not carry the identifier of access restriction, acquiring a crawling logic and a communication protocol corresponding to the second webpage according to the second webpage address;
accessing the second webpage and traversing the second webpage data of the second webpage according to the communication protocol corresponding to the second webpage; and
when traversing the second webpage data corresponding to the crawling logic, crawling the second webpage data corresponding to the crawling logic.

4. The method according to claim 1, wherein the step of respectively outputting the first webpage data and the second webpage data according to corresponding categories comprises:
respectively matching a webpage identifier carried by the first webpage data and a webpage identifier carried by the second webpage data to a stored webpage identifier;
when at least one of the webpage identifier carried by the first webpage data and the webpage identifier carried by the second webpage data does not match the stored webpage identifier, extracting a keyword of unmatched webpage data; and
outputting the unmatched webpage data according to a storage category corresponding to the keyword.

5. The method according to claim 4, further comprising:
acquiring a preset email address of a mailbox for receiving the first webpage data and the second webpage data;
extracting a department identifier corresponding to the email address and acquiring a storage category corresponding to the department identifier; and
sending the first webpage data and the second webpage data acquired under the storage category to the mailbox corresponding to the email address.

6. The method according to claim 1, wherein the step of accessing the webpage according to the network address of the second webpage, and crawling the second webpage data on the second webpage comprises:
preset a crawling time when the second webpage data of the second webpage is crawled;
when the crawling time is reached, randomly selecting an available crawling network address from a network address library; and
accessing the second webpage through the crawling network address, and crawling the second webpage data on the second webpage.

7. The method according to claim 1, wherein the step of accessing the second webpage according to the network address of the second webpage, and crawling the second webpage data on the second webpage comprises:
accessing the second webpage according to the network address of the second webpage and querying whether the second webpage is rendered completely;
when the second webpage is not rendered completely, acquiring a rendering logic corresponding to the second webpage according to the second webpage address;
rendering the second webpage according to the rendering logic corresponding to the second webpage; and
crawling the second webpage data on the second webpage which is rendered completely.

8-9. (canceled)

10. A computer device comprising a processor and a memory storing computer readable instructions, which, when executed by the processor, cause the processor to implement steps comprising:
acquiring first webpage data of a first webpage, querying a second webpage address associated with the first webpage data;
acquiring a domain name of a website corresponding to a second webpage from the second webpage address, extracting a suffix of the domain name of the website corresponding to the second webpage;
when the suffix of the domain name of the website corresponding to the second webpage is the same as a suffix of a pre-stored standard domain name, acquiring a network address corresponding to the standard domain name as a network address of the second webpage;
accessing the second webpage according to the network address of the second webpage, and crawling second webpage data on the second webpage; and
respectively outputting the first webpage data and the second webpage data according to corresponding categories.

11. The computer device according to claim 10, wherein the step of accessing the second webpage according to the network address of the second webpage, and crawling the second webpage data on the second webpage implemented when the computer readable instructions are executed by the processor comprises:
when the second webpage carries an identifier of access restriction, sending a crawling instruction for crawling webpage data on the second webpage to the proxy server;
receiving an identity authentication request returned by the proxy server, and sending a corresponding identity identifier to the proxy server according to the identity authentication request; and
when the identity identifier is successfully validated by the proxy server, receiving webpage data which is crawled from the second webpage and returned by the proxy server.

12. The computer device according to claim 10, wherein the step of accessing the webpage according to the network address of the second webpage, and crawling the second webpage data on the second webpage implemented when the computer readable instructions are executed by the processor comprises:
when the second webpage does not carry the identifier of access restriction, acquiring a crawling logic and a communication protocol corresponding to the second webpage according to the second webpage address;
accessing the second webpage and traversing the second webpage data of the second webpage according to the communication protocol corresponding to the second webpage; and
when traversing the second webpage data corresponding to the crawling logic, crawling the second webpage data corresponding to the crawling logic.

13. The computer device according to claim 10, wherein the step of respectively outputting the first webpage data and the second webpage data according to corresponding categories implemented when the computer readable instructions are executed by the processor comprises: respectively matching a webpage identifier carried by the first webpage data and a webpage identifier carried by the second webpage data to a stored webpage identifier;
when at least one of the webpage identifier carried by the first webpage data and the webpage identifier carried by the second webpage data does not match the stored webpage identifier, extracting a keyword of unmatched webpage data; and
outputting the unmatched webpage data according to a storage category corresponding to the keyword.

14. The computer device according to claim 10, wherein the following steps are further implemented when the computer readable instructions are executed by the processor:
acquiring a preset email address of a mailbox for receiving the first webpage data and the second webpage data;
extracting a department identifier corresponding to the email address and acquiring a storage category corresponding to the department identifier; and
sending the first webpage data and the second webpage data acquired under the storage category to the mailbox corresponding to the email address.

15. The computer device according to claim 10, wherein the step of accessing the webpage according to the network address of the second webpage and crawling the second webpage data on the second webpage implemented when the computer readable instructions are executed by the processor comprises:
preset a crawling time when the second webpage data of the second webpage is crawled;
when the crawling time is reached, randomly selecting an available crawling network address from a network address library; and
accessing the second webpage through the crawling network address, and crawling the second webpage data on the second webpage.

16. The computer device according to claim 10, wherein the step of accessing the second webpage according to the network address of the second webpage and crawling the second webpage data on the second webpage implemented when the computer readable instructions are executed by the processor comprises:
accessing the second webpage according to the network address of the second webpage and querying whether the second webpage is rendered completely;
when the second webpage is not rendered completely, acquiring a rendering logic corresponding to the second webpage according to the second webpage address;
rendering the second webpage according to the rendering logic corresponding to the second webpage; and
crawling the second webpage data on the second webpage which is rendered completely.

17. One or more non-transitory computer readable storage media storing computer readable instructions that, when executed by one or more processors, cause the one or more processors to perform steps comprising:
acquiring first webpage data of a first webpage, querying a second webpage address associated with the first webpage data;
acquiring a domain name of a website corresponding to a second webpage from the second webpage address, extracting a suffix of the domain name of the website corresponding to the second webpage;
when the suffix of the domain name of the website corresponding to the second webpage is the same as a suffix of a pre-stored standard domain name, acquiring a network address corresponding to the standard domain name as a network address of the second webpage;
accessing the second webpage according to the network address of the second webpage, and crawling second webpage data on the second webpage;
respectively outputting the first webpage data and the second webpage data according to corresponding categories.

18. The one or more non-transitory computer readable storage media according to claim 17, wherein the computer readable instructions are executed by one or more processors such that the step of accessing the second webpage according to the network address of the second webpage and crawling the second webpage data on the second webpage performed by one or more processors comprises:
when the second webpage carries an identifier of access restriction, sending a crawling instruction for crawling webpage data on the second webpage to the proxy server;
receiving an identity authentication request returned by the proxy server, and sending a corresponding identity identifier to the proxy server according to the identity authentication request; and
when the identity identifier is successfully validated by the proxy server, receiving webpage data which is crawled from the second webpage and returned by the proxy server.

19. The one or more non-transitory computer readable storage media according to claim 17, wherein the computer readable instructions are executed by one or more processors such that the step of accessing the webpage according to the network address of the second webpage and crawling the second webpage data on the second webpage performed by one or more processors comprises:
when the second webpage does not carry the identifier of access restriction, acquiring a crawling logic and a communication protocol corresponding to the second webpage according to the second webpage address;
accessing the second webpage and traversing the second webpage data of the second webpage according to the communication protocol corresponding to the second webpage; and
when traversing the second webpage data corresponding to the crawling logic, crawling the second webpage data corresponding to the crawling logic.

20. The one or more non-transitory computer readable storage media according to claim 17, wherein said computer readable instructions are executed by one or more processors such that the step of respectively outputting the first webpage data and the second webpage data according to the corresponding categories performed by one or more processor comprises:
respectively matching a webpage identifier carried by the first webpage data and a webpage identifier carried by the second webpage data to a stored webpage identifier;
when at least one of the webpage identifier carried by the first webpage data and the webpage identifier carried by the second webpage data does not match the stored webpage identifier, extracting a keyword of unmatched webpage data; and
outputting the unmatched webpage data according to a storage category corresponding to the keyword.
